(19) United States
(12) Patent Application Publication
(10) Pub. No.: US 2017/0337396 A1
(43) Pub. Date: Nov. 23, 2017

(54) Method and apparatus for the protection of documents and data center identifiable information that includes malware/ransomware protection and long term storage

(71) Applicants: Michael Cherry, Falls Church, VA (US); Joseph Kennedy, Stafford, VA (US); Manfred Schenk, Los Angeles, CA (US); Mark Switzer, Toronto (CA)

(72) Inventors: Michael Cherry, Falls Church, VA (US); Joseph Kennedy, Stafford, VA (US); Manfred Schenk, Los Angeles, CA (US); Mark Switzer, Toronto (CA)

(21) Appl. No.: 14/999,552

(22) Filed: May 20, 2016

(51) Int. Cl. G06F 21/62

(52) U.S. Cl. CPC G06F 21/6254

(57) ABSTRACT

A method and apparatus useful to sequester sensitive identifiable data from the data associated therewith and store this sensitive data in a shielded limited access structure while the associated data is periodically processed in a data center while concurrently scanned for potential malware/ransomware script. Once thus cleaned the data processed in the data center is then converted to a read only form and as thus converted brought to the limited access structure where it is screened once again for script tags and if none are found is then merged with the corresponding identifiable data to be printed and mailed. This repeated screening pass together with the periodic nature of the data center's operations combine to minimize all potential exposure to unwanted data contamination while the secured nature of the limited access structure can be used for secure long term storage.

### BACKGROUND OF THE INVENTION

### Reference to Related Applications

None.

### STATEMENT CONCERNING GOVERNMENT INTEREST

None.

### FIELD OF THE INVENTION

The present invention relates to data security and more particularly to a method and apparatus useful to sequester bulk identifiable information within a shielded and secured enclosure while the other data associated with the identifiable information is periodically updated, and also cleaned of unwanted script and malware, and as thus sanitized in the course of each periodic processing is then merged with the corresponding identifiable information and printed within the secured enclosure, with the sanitized and merged data then remaining therein as a reference record.

### DESCRIPTION OF THE PRIOR ART

Those engaged in information technology, along with the rest of us who are now increasingly interacting with this ever expanding electronic information exchange, are all observing with substantial alarm the exponential explosion of unwanted privacy breaches involving large, specialized primary data centers that are regularly somehow penetrated to either expose the private details of the center's customers or even demanding ransom. Typically these group data penetrations target specialized data banks storing data that is of little interest to individuals bent on minor mischief, (e.g., someone looking for a credit card number to buy a large screen television set over the Internet) but is of significant interest to larger, more strategic, players that will and have invested the substantial group efforts generating all sorts of malware tainted script that ends up penetrating even the most well sheltered security barriers. Once the penetration occurs all sorts of ransom demands then follow.

At the core this contest is focused at obtaining the identity of persons associated with some very significant private financial information, significant health information, or even membership in some clandestine government service, where the consequence of such penetration are not just mere mischief but may constitute a part of fiduciary information resale endeavor or ransomware based on some massive extorting enterprise, and the like. This exposure to periodic identity breaches frequently stems from malicious e-mails, phishing attacks and infected third party Internet access that may include suppliers, business partners and even auditors that relies on the central underpinnings of the economic model of this self-funded public communication network that invariably provides at least the doorway exchange with these specialized data banks but relies for its whole existence on advertising revenues and such advertising is more efficient and of more value, when at least some individual data are disclosed and most of those providing security and privacy in this medium accept these economic model constraints.

For example U.S. Pat. No. 6,442,687 to Savage and U.S. Pat. No. 9,262,608 to Savage et al. both recognize the significance of personal identity data and therefore separate the identity from the action (transaction) by encrypting the one or the other at the respective servers between which the communication occurs. While suitable for the purposes intended, these efforts are still confined by the facility Internet provides and the resulting solution defines for the malevolent extorter the number of decryptions that need to occur to reach the desired end while shielded by the anonymity of this communication medium. Alternatively, U.S. Pat. No. 9,098,844 to Davis et al. exemplifies the other end of this security providing effort effected in a mobile communication device secured by multiple layers of biometric scanning together with passwords, credit card numbers and the like, that while suitable for the purposes intended also provides a defined task and anonymity for the miscreant. Since the safeguarding remedy of a new password or account number is simple and the use convenience of this mobile communication device is great this occasional risk of failed biometric isolation is acceptable. Simply, the onset of the Internet within both large and small scale data centers has made unauthorized intrusion so simple that fundamental changes are an absolute requirement.

This risk associated with penetration of specialized small and large data centers is both substantially different in kind and astronomically greater in consequence. Any data processing facilities of such data centers must therefore continuously scour for all the unwanted clutter that may have been brought in through the porous Internet connection while also separating and sequestering the identifiable data of each of its customers in a signal impervious separate structure during its data collection needed for the periodic batch reporting with the data center operations then based on substituted arbitrary symbols. Of course, these same concerns over security, along with basic economics, demand that only a limited number of trusted data center employees attend to this task and for these reasons deference to automated processes is preferred particularly when the process is inherently secure like a bunker that is then made even more secure as result of its repeated operations. A method and apparatus that accomplish all these ends in the course of the regular operations of a data center are therefore extensively desired and it is one such method and apparatus that are disclosed herein.

### SUMMARY OF THE INVENTION

Accordingly, it is the general purpose and object of the present invention to provide a method and structure useful to sequester all identifiable data from the associated other data by substituting for the identifiable data an array of corresponding arbitrary symbols while the data processing operations are carried out along with a concurrent process deleting parts or segments from any attached script that includes any of the several character combinations associated with malware, thereby diminishing the principal mechanisms of malware inclusion sequences are diminished in the course of each repeated processing cycle to inoperability and then to non-existence with the sequestered identifiable data then replaced for the temporary symbols in a safe, limited access area protected by biometric screening to facilitate the periodic batch reporting or printing.

A further object of the invention are to provide a script screening sequence effected upon each data update within a data center.

Yet other and additional objects of the invention shall become apparent upon the review of the description that follows in association with the drawings appended hereto.

Briefly, these and other objects are accomplished within the present invention within the foregoing data center adjunct limited access structure that may include electromagnetic shielding and its own electric power source and also an access controlled entry enabled at scheduled intervals and secured by biometric verifications that discriminate such trusted person or persons as may be associated with the data center for a predetermined period of time sufficient to effect any data processing, batch printing or other operations on a dedicated terminal or printer also situated in this limited access structure. The resulting complement of the adjunct limited access structure will then also include all such processing and memory capabilities as may be necessary to support the biometric recognition and also the processing and printing which may be used to conceal any correspondence table or array between the identifiable data and the data associated therewith identified by arbitrary correspondence symbols, all shielded by locking doorways that have limited time apertures during which access is allowed. These isolating aspects can then also serve as a fully secure meeting or viewing cubicles where sensitive information can be viewed and stored.

As thus implemented the adjunct structure is enabled to receive the trusted person within any one of the predetermined time apertures where the appropriate biometric scanning, exemplified herein by a iris scanner, is carried out and, if verified, the original information, including updates, that accompanies the trusted person is examined, and all its identifiable data replaced by the corresponding symbols clandestinely stored in, for example, the printer memory, and as thus modified returned to the data center for batch processing, while the original remains sequestered in the adjunct structure. In the course of this first batch processing cycle an intermediate output is generated that is then converted to Text and in this form examined for the presence of a set of symbol sequences that are indicative of malware, ransom ware or other unauthorized combinations that then enable a delete and notice operation to remove the offending matter and also give notice of the existence thereof. In this manner the integrity of the unauthorized sequence is immediately disrupted with any of its remainder then reduced to oblivion in the course of subsequent batch processing cycles.

It will be appreciated that the initial batch processing cycle, with its initial unwanted character removal cycle, may be repeated several times both to remove possible further unwanted characters and also for comparison purposes to test the process efficacy, and once these are satisfied the processed product to the data center batch processing stream while the data center while the backup recovery restart points are stored in the adjunct structure. The batch processing output is then merged with identifying data corresponding to each symbol and printed. In this manner not just one but several cleaning cycles are performed while the information of ultimate importance, the customers' identifying data, is fully sequestered and only after that are the two sets of data merged. The occasion for the entry of malware into the identifying data subset is thus fully minimized in a process that repeats both in a single batch processing cycle and then keeps on cyclically repeating as monthly reports and periodic statements are generated.

### BRIEF DESCRIPTION OF THE DRAWINGS

FIG. 1 is a diagrammatic illustration of the inventively arranged secured structure associated with a typical data center and including a timed entry, a biometric iris scanner, a printer and a dedicated computer, each including a processor and a memory supporting their use where such memories are each of sufficient capacity to clandestinely store a concealed correspondence table, or array, containing the identifiable data in association with corresponding symbols;

FIG. 2 is a sequence diagram illustrating the inventively carried out script identification and removal process carried out in the course of data processing within the data center in accordance with the present invention; and

FIG. 3 is yet another sequence diagram illustrating the document printing process and tag removal sequence for removing any remaining unauthorized tags from the data output of the process sequence illustrated in FIG. 2 and then merging said output with the identifiable data within the secured structure to effect printing.

### DESCRIPTION OF THE SPECIFIC EMBODIMENT

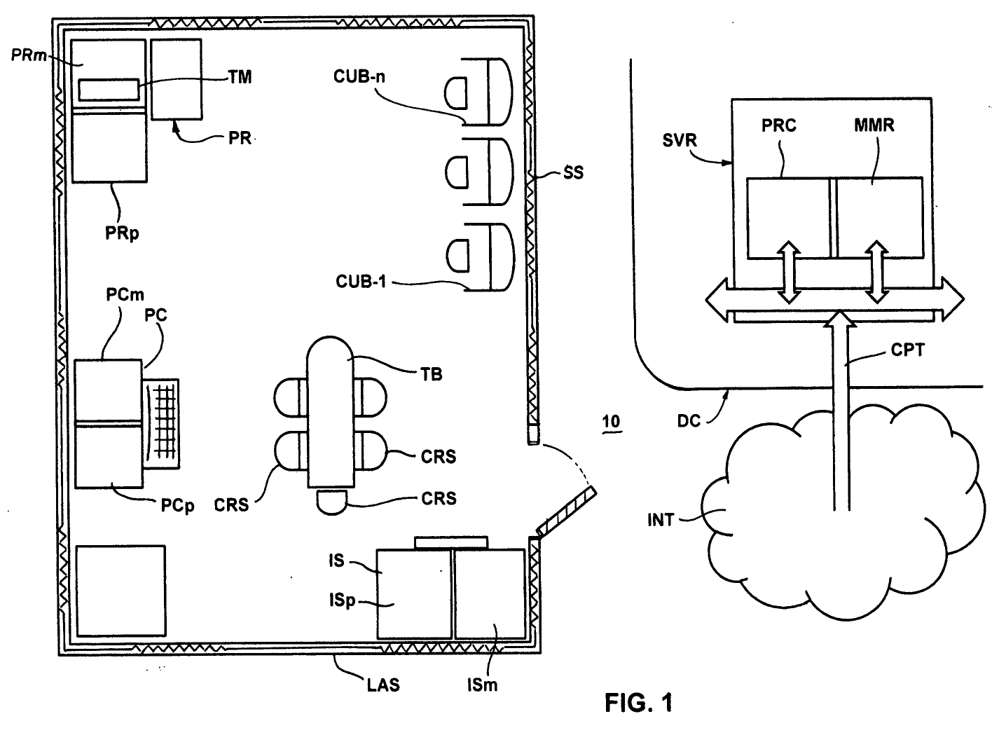

As shown in FIG. 1, the inventive implementation of the instant identifiable data sequestering system, generally designated by the numeral 10, includes a data center DC and an adjunct limited access structure LAS, sometimes referred to herein as a bunker, implemented with a surrounding shielding screen SS in the form of a radio frequency shielded enclosure provided with a biometric scanner like an iris scanner IS, a printer PR, and a stand-alone, or dedicated, computer PC each enabled by a corresponding associated processor ISp, PRp and PCp and memory ISm, PRm and PCm. Also included in structure LAS is its own electric power supply connected to power the above equipment and a set of viewing cubicles CUB-1 through CUB-n within which sensitive or secret information stored in the computer PC can be displayed.

In addition to these functions the several devices included in the bunker LAS also include elements associated with their externally visible specific functions like a scanning aperture, print mechanism and/or a keyboard, thereby each representing to those that are unfamiliar a functioning item within which one of the memories ISm, PRm and PCm may also function as a concealed location for storing a hidden correspondence table or array listing the several identifiable data sets with a corresponding distinct replacement symbol, illustrated herein as a table TM, stored in this exemplary instance within the printer memory PRm. To enhance the difficulty for those bent on penetrating this puzzle the limited access structure LAS also includes a time limited doorway DW that enables entry and exit which, of course, is further secured by the above described biometric scanning that allows occupancy for only a limited time period. In this form the limited access structure LAS may comprise a part of the data center DC, or may form a stand alone structure that offers little occasion for visits except by those entailed in the batch processing tasks, a structure that inherently requires full exclusion of communication devices that can be reached by outside signals, a requirement that affirmatively precludes the presence all Internet communication devices. A conference table TB with a set of chairs CRS may be included in the limited access structure LAS to expand its use as a secure area where sensitive discussions and/or sensitive draft reviews can take place.

The data center DC, in turn, also may take many forms in light of the particular nature and amount of the data processed, concerns over power consumption, equipment rack spacing, and the like, with its minimum form including at least one server SRV tied through at least one communication port CPT to the Internet INT over which most of the transactions carried out via the Internet enabled commerce, medical information exchanges, or other data collection exchanges occur. This communicated data is processed on an incoming basis and therefore is handled on a preferential basis in a processor PRC associated with the server SVR to provide the updating data referred to above while handling the above batch processing tasks is handled during its lower activity periods and it is this intermittent task switching that provides the pathway for the introduction of all sorts of malware that often burdens our Internet that then eventually migrates into the memory MMR that is also associated with the server SV. It is at this point that most of the commercially available data security systems are enabled, all generally focused at intercepting and disabling the progression of a ‘virus’ or malevolently designed process into the data center's main processing elements.

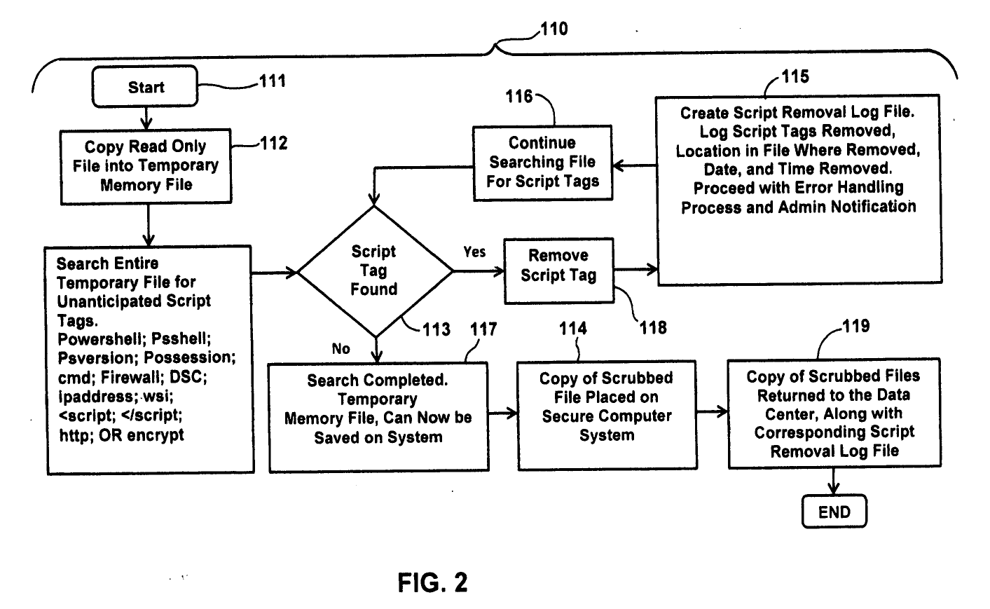

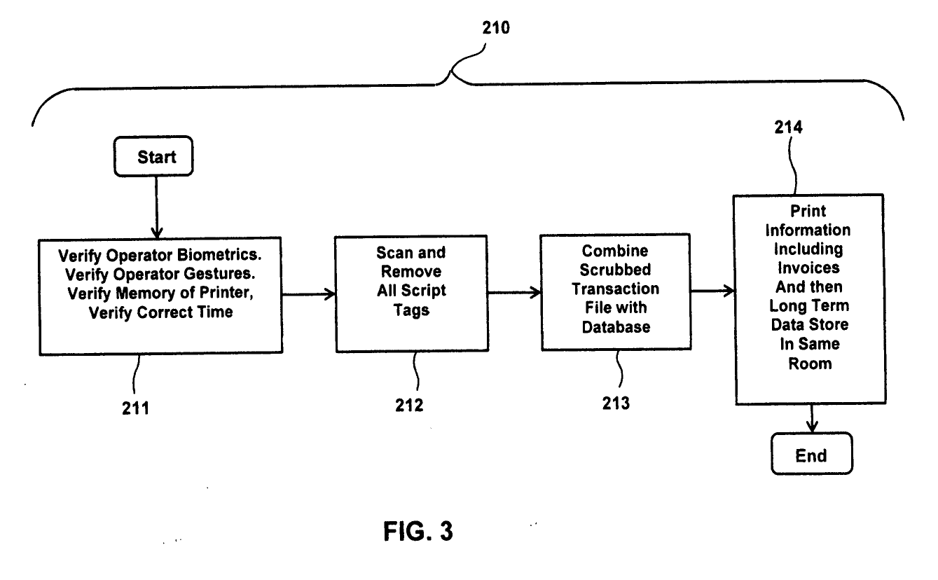

While these commercially available data security systems are generally well able to resist such targeted malware the current explosion in data handling capacity of a typical data center has led to further automation of its workflow managing system that is now enabled by highly simplified scripts which now also infest the Internet data streams and in proper combinations, can redirect the workflow to full catastrophic stoppage, wholesale data release or irreplaceable destruction that is then used to extort and it is this newly appearing invasion vector that is addressed in the process shown in FIGS. 2 and 3 where the first sequence generally designated by the numeral 110 and shown in FIG. 2, is carried out wholly within the data center DC commencing within step 111 with a copy process of the data center's batch processing output onto a portable, relatively permanent, memory device such as a read only memory or ROM and as part of this copying process scans the copied file in step 112 for unanticipated script tags like:
“powershell; psshell; psversion; possession; cmd; firewall;
DSC; ipaddress; wsi; <script; </script; http; OR encrypt.”
   When any such script tag is found then in branch step 113 the step 114 is enabled to remove the tag and concurrently a log of it is noted in a script removal file maintained in step 115 which also includes a notification to the data center DC system administrator. Once thus noted the copying and removal sequence is continued in step 116 with the data now cleaned returning to the branching step 113 to continue with the copying process in step 117 with the scrubbed copy of the data then stored in the limited access structure LAS in step 118 while a copy of the scrubbed and unmerged data is returned to the data center in step 119 along with the corresponding script removal log.

Once the data, scrubbed for the first time for script tags, is in the secured structure a second sequence illustrated in FIG. 3 under the general designation by the numeral 210, first verifies in step 211 the biometric bonafides of the operator, the correct time and the presence of the appropriate correspondence table TM concealed in the memory PRm associated with the printer and once these are verified and established a second scan for script tags is performed in step 212 generally according to the criteria set out in the sequence 110 illustrated in FIG. 2. Once this repeated scan is completed the transaction is then merged with the identifiable information in accordance with the correspondence table TM in step 213. In this manner not just one, but two scanning and cleaning cycles are performed during each batch processing cycle which, itself, recurs on a periodically repeating schedule, insuring that all malicious script is eventually removed. The merged and combined data is then printed in step 214 and also stored in the limited access structure LAS in a long term data store.

Those skilled in the art will appreciate that the foregoing sequence is particularly useful with data center operations that already use substitute symbols like social security number, health coverage membership numbers, and the like, as part of usual operations in order to simply reduce the data volume and/or the inherent ambiguities misspelled names create, and the notion of an identity correlation table TM is therefore a familiar subject. What is, however, of utmost significance is the security of this correlation table from all possible disclosure which is currently endangered by the increased reliance on automated workflow managing systems that are coming on stream encouraged by their promises of reduced staffing that inherently dictate a control simplified format of the automated process. This new infection portal combined with the data bulk currently handled in a typical data center produce an inherently risk prone combination that can only be resolved by highly flexible response mechanisms as is currently described

Obviously many modifications and variations of the instant invention can be effected without departing from the spirit of the teachings herein. It is therefore intended that the scope of the invention be determined solely by the claims appended hereto.

It is claimed:

1. A method for sequestering identifiable data from the other data associated therewith in the course of processing said other data in a data center, comprising the steps of:
providing a limited access structure in an associated relationship with said data center, said limited access structure including a biometric scanner, a dedicated computer and a printer, each said scanner, computer and printer including an associated memory;
generating a correspondence table including each said identifiable data in association with a corresponding distinct replacement symbol;
concealing said correspondence table in a selected one of said associated memories;
processing said other data in association with a corresponding one of said distinct replacement symbol in said data center; and
merging within said limited access structure each said other data processed in the data center with said identifiable data in accordance with said correspondence table.

2. A method according to claim 1, comprising the further step of:
scanning in the first instance for unwanted script in the course of executing said step of processing said other data in said data center.

3. A method according to claim 2, wherein:
said limited access structure is isolated from electromagnetic signals including an internet signal.

4. A method according to claim 2, comprising the further step of:
scanning in the second instance for unwanted script prior to the step of merging in said limited access structure.

5. A method according to claim 1, wherein:
said step of processing said other data is repeated on a recurring basis.

6. A method according to claim 5, comprising the further step of:
scanning in the first instance for unwanted script in the course of executing said step of processing said other data in said data center.

7. A method according to claim 2, comprising the further step of:
scanning in the second instance for unwanted script prior to the step of merging in said limited access structure.

8. A method according to claim 2, wherein:
said limited access structure is isolated from electromagnetic signals including an internet signal.

9. A method for sequestering identifiable data from the other data associated therewith in the course of processing said other data in a data center, comprising the steps of:
providing a limited access structure in an associated relationship with said data center, said limited access structure including a plurality of data processing devices each including an associated memory;
generating a correspondence table including each said identifiable data in association with a corresponding distinct replacement symbol;
concealing said correspondence table in a selected one of said associated memories;
processing said other data in association with a corresponding one of said distinct replacement symbol in said data center; and
merging within said limited access structure each said other data processed in the data center with said identifiable data in accordance with said correspondence table.

10. A method according to claim 9, wherein:
said limited access structure is isolated from electromagnetic signals including an internet signal.

11. A method according to claim 10, comprising the further step of:
scanning in the first instance for unwanted script in the course of executing said step of processing said other data in said data center.

12. A method according to claim 11, comprising the further step of:
scanning in the second instance for unwanted script prior to the step of merging in said limited access structure.

13. A method according to claim 12, wherein:
said step of processing said other data is repeated on a recurring basis.

14. A method for sequestering identifiable data from correspondingly associated other data in the course of processing said other data in a data center, comprising the steps of:
providing a limited access structure in an associated relationship with said data center, said limited access structure including a biometric scanner, a dedicated computer and a printer, each said scanner, computer and printer including an associated memory and each said scanner, computer or printer being without a communication connection with the exterior of said limited access structure;
generating a correspondence table between each identifiable data in association with a corresponding distinct replacement symbol;
concealing said correspondence table in a selected one of said associated memories;
processing said other data in association with a corresponding one of said distinct replacement symbol in said data center; and
merging within said limited access structure each said other data processed in the data center with said identifiable data in accordance with said correspondence table concealed in said selected one of said associated memories.

15. A method according to claim 14, wherein:
said limited access structure is isolated from electromagnetic signals including an Internet signal.

16. A method according to claim 15, wherein:
said limited access structure includes a timer controlled entry.

17. A method according to claim 16, wherein:
said limited access structure includes a shielded viewing facility.

18. A method according to claim 17, wherein:
said limited access structure includes a shielded conference section.
